(19) United States
(12) Patent Application Publication
(10) Pub. No.: US 2021/0285722 A1
(43) Pub. Date: Sep. 16, 2021

(54) METHOD AND DEVICE FOR DRYING BULK MATERIAL

(71) Applicant: Luciano Tamburini, Klagenfurt-Viktring (AT)

(72) Inventor: Luciano Tamburini, Klagenfurt-Viktring (AT)

(21) Appl. No.: 16/336,751

(22) PCT Filed: Sep. 27, 2017
(86) PCT No.: PCT/EP2017/074554

§ 371 Date: Mar. 26, 2019

(30) Foreign Application Priority Data
Sep. 27, 2016 (AT) A50858/2016

(51) Int. Cl. F26B 1/00; F26B 3/06; F26B 7/00; F26B 9/06; F26B 21/14; B02B 1/02; B02B 1/08

(52) U.S. Cl. CPC F26B 1/00; F26B 3/06; F26B 7/00; F26B 2200/06; F26B 21/14; B02B 1/02; B02B 1/08; F26B 9/063

(57) ABSTRACT

The invention relates to a method for convective drying of bulk material in a container (1), wherein in a drying step a gas mixture flows around the bulk material to be dried in the container (1), which gas mixture absorbs water contained in the bulk material to be dried and is then discharged from the container (1), wherein a cooling step is carried out before the drying step, in which the bulk material is brought to a temperature lower than the ambient temperature, and both the cooling step and the drying step take place in the same gas-tight container (1).

### FIELD OF INVENTION

The invention relates to a method for convective drying of bulk material in a container, wherein in a drying step a gas mixture flows around the bulk material to be dried in the container, which gas mixture takes up water contained in the bulk material to be dried and is subsequently discharged from the container, as well as a corresponding drying device. In particular, the following bulk materials can be considered: agricultural goods, in particular harvested goods (cereals, maize, soybeans pulses, etc.), food and animal feed, granular materials (plastic, stone and pharmaceutical granulates) and technical products.

### DESCRIPTION OF THE PRIOR ART

Many agricultural products and above all harvested goods are generally preserved by convection drying. In convection drying, a heated carrier gas (e.g. air) flows around the material to be dried, transferring the heat of the gas to the material and transferring moisture to the Gas. In general, fine dry goods are able to release moisture faster into the environment than coarse-grained goods. The air drying process depends on the air humidity, the air temperature, the air speed in the dryer and the quality of the surface of the material to be dried. Usually the air is heated with oil or gas furnaces. Common dryer types are: container and silo set dryers, roof shaft dryers, continuous dryers, warehouse ventilation dryers and belt drying systems. Furthermore, it is possible to distinguish radiation drying, contact drying and vacuum drying, wherein contact drying and especially convection drying are the most widely used methods for drying harvested crops.

Drying is essential for the preservation of many plant crops. Due to the high energy requirements of the drying systems, drying costs can amount to more than one-third of the production costs, which is why energy-efficient drying is a decisive aspect for businesses and, above all, for the competitiveness of grain producers.

A method for the convective drying of wet or moist material is known from DE10250784 B4, wherein the material to be dried is acted upon in a dryer with a drying gas which, during the drying process, absorbs water contained in the material to be dried and which, after the drying process, is discharged from the dryer as waste gas. Since the drying gas is dehumidified before it is heated and fed to the dryer, it cannot be an inert gas because artificially produced inert gas would not contain moisture.

RU 2392793 C1 relates to a method for drying and storing cereals in a granary using cooled air for drying in two phases. In the first phase, outside air or supply air is supplied to an air cooling unit and cooled to a temperature below the dew point, wherein moisture contained in the air is separated as condensate. The cooled air is then fed into the grain mass in the grain store to cool the grain mass, which may have been exposed to self-heating by bacteria during storage. In the second phase, the air that is condensed out is heated to a temperature equal to or higher than the outside air temperature by a heat exchanger.

DE 2947759 A1 also works with a cold and dehumidified gas namely air, for the drying of cereals. The air must be circulated, as the cold drying process means that moisture absorption is very low.

However, the use of air for drying may cause micro-organisms contained in the cereal to become active, creating the risk of spoilage of the cereal.

Often, a drying plant must be able to accept and process (dry) large quantities of crop in a short period of time, as in recent years the capacity of some commercially available modern combine harvesters has increased and bad weather conditions can shorten the time window from harvest (threshing) to storage consolidation. Ideal weather conditions rarely occur when the crop (e.g. grain) has reached its final ripeness so rapid storage is essential, as the physical storage properties of the crop depend largely on the climatic condition (moisture content) and the temperature during harvesting and storage. Microorganisms and biochemical degradation processes in the grain lead to time-dependent losses, which can range from a reduction in quality and weight to complete spoilage. In silo dryers, the storage space and the dryer function are combined in one unit which on the one hand saves space, but with conventional drying in ventilated and uncooled containers such as some silos, with large grain or irregularly large harvests and above all with high crop moisture such as maize, the desired drying can be optically achieved on the surface of large grains, but there is still residual water inside the grain. This results in a sweating process as water migrates from the inside to the outside and accumulates on the surface. This water provides an ideal breeding ground for fungi, bacteria and other microorganisms, resulting in loss of crop quality. Pest infestation by insects should also be mentioned here. However, quality losses are also achieved by overdrying the crop, excessively long drying periods or excessively high temperatures.

### OBJECT OF THE INVENTION

It is therefore an object of the invention to overcome the disadvantages of the prior art and to propose a method for wet storage and drying of bulk materials and granular material, by means of which bulk materials, especially harvested goods, can be stored wet immediately after harvesting, then dried and stored dry.

### SUMMARY OF THE INVENTION

The object is solved by a method for convective drying of bulk material in a container, wherein in a drying step a gas mixture flows around the bulk material to be dried in the container, which gas mixture absorbs water contained in the bulk material to be dried and is then discharged from the container. It is provided that before the drying step a cooling step is carried out in which the bulk material is brought to a temperature lower than the ambient temperature, wherein both the cooling step and the drying step take place in the same gas-tight container.

This procedure has the advantage that storage space is saved and bulk material, preferably large quantities of harvested material, can be introduced into the gas tight container immediately after threshing and stored in a cooled manner, which greatly reduces loss of quality and damage to the bulk material, which is why storage independent of the weather is also possible with the drying device according to the invention.

In order to prevent fungi, bacteria (Escherichia coli, enterobacteria, especially salmonella), other microorganisms and insects from having a breeding ground or favorable living conditions and to reduce the germ content, the drying step takes place in an inert atmosphere, since, as previously mentioned, condensation water can form on the surface of biological bulk material during and after the drying step.

The inert atmosphere is created by introducing an inert gas mixture into the container. This has the advantage that the gas mixture is mixed stoichiometricany in advance and can be fed into the container if required which makes it easy to gasify the container afterwards.

According to the method in accordance with the invention, the inert gas mixture consists of a large amount of nitrogen, carbon dioxide and at least one noble, gas, preferably argon.

In principle, the method can be carried out with any type of inert gas, wherein the above-mentioned combination offers the advantage that nitrogen can be produced cost-effectively with the aid of a pressure swing adsorption system (PSA) and the colorless and odorless gas behaves neutrally and does not leave or enter into any chemical residues or reactions on the bulk material.

A preferred embodiment variant of the method according to the invention provides that the inert gas mixture consists of 70 to 95%, in particular 90% nitrogen, 5 to 10%, in particular 7% argon and 2 to 4% in particular 3% carbon dioxide, since nitrogen, as already mentioned, is an inert and cost-effective filling medium and carbon dioxide inhibits the growth of some fungal species and yeasts as well as certain bacteria. In higher concentrations the germination of fungal spores is already prevented and these are destroyed. Due to the higher density of argon compared to the medium air, argon (as well as carbon dioxide) has good displacement properties. It is preferably provided that the inert gas mixture is heavier than the medium air in order to displace it from the inside of the container during the inerting of the container.

In a preferred variant of the method according to the invention in a final phase of the drying step, i.e. shortly before the final storage, the dosage of the carbon dioxide in the inert gas mixture is increased to 5 to 20% in order to sterilize the bulk material so as to achieve an increased germicidal effect and thus sterilization through the increased carbon dioxide concentration.

In order to have the inert gas mixture in stock for the inerting and post-gassing of the gas-tight container, an inert gas accumulator is used in a preferred embodiment variant of the method according to the invention, which is connected to a cylinder store and a dosing station. Via a solenoid valve and an inert gas supply line, the inert gas mixture is preferably brought to a pressure of 30 to 40 bar by means of a compressor and fed into the inert gas storage tank.

Due to the inert atmosphere, bulk materials of all kinds can be heated at 20 to 110° C. depending on the application and be dried with a high degree of efficiency. For sensitive bulk materials, especially those from agriculture or biological products of the pharmaceutical industry, a gentle temperature of preferably 30 to 45° C. is chosen in order not to destroy protein structures, enzymes, pigments, antioxidants or vitamins in food, for example, in order to maintain a high germination capacity of grains (low dry matter losses) and biological value of the bulk material. For this purpose, the inert atmosphere needs to protect the bulk material from fungi, in particular storage fungi and their metabolites such as mycotoxins, microorganisms such as plant single- and multicellular organisms, DNA and RNA fragments, plasmids and viruses, fumonisins, Fusarium species and insects. At a drying temperature between 100 and 120° C. strong impairments of the biological value can occur due to, for example, the Maillard reactions. In granular crops, these processes already take place at 80° C. in not yet fully ripened grains with an increased content of reducing sugars. If the grain moisture content is less than 20%, the risk of damage is greater than with higher grain moisture content. Due to the inert atmosphere, however, lower drying temperatures can be selected, as numerous chemical reactions require oxygen for their process in addition to an elevated temperature. For example, the air temperature for drying seeds should not exceed 36° C. to avoid germ damage.

In the drying step the gas mixture is preferably heated via a first heat exchanger connected to a hot water storage tank, preferably to the following temperatures: 35 to 45° C. or 41 to 65° C. or 55 to 80° C. and fed into the interior of the container. The temperature of the gas mixture after the first heat exchanger is selected according to the following parameters: type, shape, size and hygroscopic behavior of the bulk material to be dried, residence time of the bulk material in the container, fan power of the fans and a desired degree of drying.

The germicidal or germ-reducing effect of the inert gas enables the bulk material to be stored for a longer period of time and biologically valuable ingredients of food and feedstuffs remain intact. Due to the high hygienic effect of the gas mixture combined with gentle drying, the method can also be used for demanding applications.

Other dryer systems, such as batch dryers or circulation dryers, can also be used for the method according to the invention if these are converted to gas-tight.

In a preferred embodiment variant, the bulk material is shifted in the drying step. This shifting of the crop during drying gives the grain a resting phase, which provides sufficient time for water to migrate (capillary migration) from the inside of the grain to the surface of the grain, so that condensation water produced can be absorbed by the inert gas mixture and removed. The lower loss of crop ultimately results in a higher crop yield.

A further advantage of the method according to the invention is that no additives, such as insecticides or pesticides, are required for pest control, sterilization and preservation of the bulk material in addition to the inert gas in order to create hygienic storage conditions in the short or long term and to preserve the bulk material. In order to achieve high efficiency, i.e. to kill microorganisms, it is recommended for some foodstuffs, depending on the bulk material, to keep the inert gas concentration in the container for a period of 6 to 40 weeks, preferably 3 to 7 weeks, at a temperature preferably greater than 15° C. at over 9.8%, preferably over 99%, as this “sterilization” or the process of decimating germs also depends on the duration of the application in addition to some process parameters.

A preferred embodiment variant of the method according to the invention provides that the hot water storage tank is fed from at least one of the following sources: a heat pump, geothermal energy, process heat or solar collectors. The use of at least one heat exchanger connected to at least one hot water storage tank, which is fed by at least one heat pump, which in turn is connected to an energy source, has the advantage that ecological energy sources, such as. geothermal energy or solar power, updraft power plants, hydroelectric, power etc. can be chosen in order to act on the one hand in an ecologically positive way and on the other hand to save energy costs.

The energy for the heat pump can be taken from a cold water storage tank, a well or another heat source with heat recovery. In a preferred embodiment variant of the method according to the invention, part of the heat is retained in the circuit by means of process heat recovery, since process heat from water, which comes from the cold water storage tank and was heated by heat exchange in the second heat exchanger, is recovered by means of a heat pump. This can in turn save costs and further emphasize the ecological aspect of the method according to the invention, as energy can be used sparingly and efficiently and there are no environmentally harmful vapor and odor emissions (e.g. carbon dioxide) as is the case with heating with oil and gas, for example.

In a preferred embodiment variant, the container is designed so that the inert gas mixture flowing through the gas line into the container displaces the air in the container through the upper valve and the outlet. The upper valve remains open until the predetermined amount of inert gas is present in the container. If a maximum value of 03-2%, preferably 1-2% or 13-3.5%, preferably 2-3% residual oxygen is reached in the container, the upper valve and the inert gas supply close. The supplied gas mixture is then circulated in a closed system by at least one fan, preferably a radial fan. Data, such as internal container pressure, temperature, humidity, gas flow and residual oxygen content, are monitored by a PLC program. In addition, the inerting of the container greatly reduces or completely prevents the risk of explosion caused by dust or fermentation processes.

In a preferred embodiment variant of the method according to the invention, a control unit is used to adjust the Slow rate of the inert gas mixture, which enables the pressure and flow rate of the gas mixture to be controlled. This makes it easy to set the optimum flow rate for the product. Due to the drying step and the inert atmosphere, the bulk material can be stored in the container both for a short time, e.g. by a circulation dryer, and for a long time, preferably 5 to 11 months.

One of the preferred embodiment variants of the method according to the invention stipulates that the flow velocity of the inert gas mixture depends on the composition and type of the hulk material, more precisely on its moisture content and the temperature at which it is to be dried. These parameters are determined on a case-by-case basis, with a preferred gas volume of 20 to 30,000 kg/h. Slight gas losses may occur during the drying process. If the residual oxygen concentration in the container is too high, the inert gas mixture provided in the inert gas storage tank can be used for re-gasification.

As mentioned above, bulk material and especially harvested material (cereals, wheat, etc.) are stored immediately after harvesting in the gas-tight container in a cooled condition in order to minimize germination activities. During storage, a cooling step already takes place, which is preferably converted by means of cooling air. The duration of cooling of the bulk material in the container is from one hour to one day and preferably from one to two days.

It is provided in a preferred embodiment variant of the method according to the invention to use ambient air as cooling air. This is used for cost reasons and lowers the temperature in the container during the cooling step to lower values than those of the ambient temperature, preferably to 5 to 13° C. and especially preferably to 6 to 12° C. The cooling air is preferably cooled by at least one second heat exchanger connected to a cold water storage tank.

In a variant of the method according to the invention, the cold water storage tank is preferably fed from a well or a heat pump. Other cold sources, such as a river or lake, are conceivable. The advantage is that additional bulk material can be introduced into the container during the cooling step, as this also means that additionally introduced harvested material can be stored in a cooled condition immediately after harvesting.

A further advantage of the method according to the invention is that the gas mixture is circulated in a preferred embodiment variant in a gas-tight closed system, as this reduces environmental pollution and costs. The problem is that, depending on the properties of the wet or moist material to be dried, the exhaust gas produced by known drying processes can be contaminated with odors and partly with germs. Such exhaust gases should not normally be released into the environment without prior treatment. In particular, there are problems of public acceptance for the drying of grain with a high water content (maize) which the operators of such plants have to deal with. The inert atmosphere advantageously promotes the degradation of organic components in the material to be dried, resulting in hygienization (sterilization).

The gas mixture saturated with moisture in the drying step is condensed out before reheating in a particularly preferred variant of the method according to the invention, i.e. most of the water contained is separated out, which means that the gas only needs to be supplemented when necessary and no complete gas change has to take place. With this, method variant, the drying gas is guided in a dosed circuit during the drying process and the moisture is condensed out. Thus, odors and germs are eliminated with the method by the inert gas mixture and discharged from the dryer with the condensate. This saves the use of cost-intensive biowashers or biofilters in the exhaust gas stream.

The toxin content of the harvested crop is preferably tested by random sampling during crop acceptance and/or storage, wherein toxin levels for a large number of different toxins are preferably below 10 μg/kg. A comprehensive quality control at the acceptance of the crop (pre-cleaning, optical sorting) can achieve an efficient reduction of mycotoxins in the end products, especially in maize, wherein a high quality of the product can be achieved along the entire value chain.

In a further preferred variant of the method in accordance with the invention, a bulk material feed, in particular in the form of a lift and a discharge mechanism, in particular in the form of a discharge screw, are possible means of introducing bulk material into the gas-tight container in the drying device. To shift the bulk material in the container, a part of the bulk material in the lower part of the container is discharged in layers by the horizontally circulating and rotating discharge screw in the middle after an appropriate drying time. After discharge, a slide located below the container plate is preferably closed pneumatically. A horizontal paddle worm conveys the discharged bulk material to a lift, which transports it upwards and, with the inlet flap open, transports it back into the container via a feed mechanism such as preferably a conveyor belt, a worm or a chute. This shifting ensures that the bulk material is adequately mixed and that no moist “nests” can form in a bulk mass. In the case of granular crops, the grain is given a resting phase during this type of shifting in order to discharge water contained inside the grain to the surface. In the case of a gas-tight closed system, both the equipment for bulk material feeding and for discharge and shifting must be gas-tight.

In a preferred embodiment variant of the method according to the invention, the container, preferably a silo, or a circulating dryer or other dryer, is continuously and automatically fed with the bulk material to be dried, the cooling step is initiated, inertized, the drying step is initiated and after completion of the drying step emptied, and the dried and at least germ-reduced bulk material is fed to further processing. Inside the container there are sensors and probes, which measure the humidity and temperature. During the drying step, a control unit determines interval times for the shifting of the bulk material; more precisely, when the bulk material is preferably removed via a discharge screw and transported vertically upwards and back into the container via a crop feeder, preferably a lift. In addition to the interval times, the control unit also regulates the influence on the heat transfer between the heating medium, preferably in the form of a heat exchanger, and the bulk material, preferably harvested material, as well as the flow speed of the gas mixture by regulating the blower output.

Preference is given to reducing the initial moisture content of the crop from 30 to 40% to 10 to 14% for maize or from 12 to 18% to 8 to 10% for wheat or soybeans in several processes of repositioning in the container, at a specified time and at a low temperature, by gentle drying. By automating the aforementioned processes, simple process control is possible because, in contrast to many conventional processes, some process parameters can be kept constant.

### BRIEF DESCRIPTION OF THE DRAWINGS

The invention is now explained in more detail by reference to an embodiment example. The drawings are exemplary and are intended to illustrate the idea of invention but in no way to restrict it or even to reflect it conclusively.

The drawings show as follows:

FIG. 1 shows a schematic representation of the cooling process of the method according to the invention;

FIG. 2 shows a schematic representation of the inerting process of the method according to the invention;

FIG. 3 shows a schematic representation of the drying process of the method according to the invention;

### BRIEF DESCRIPTION OF THE PREFERRED EMBODIMENTS

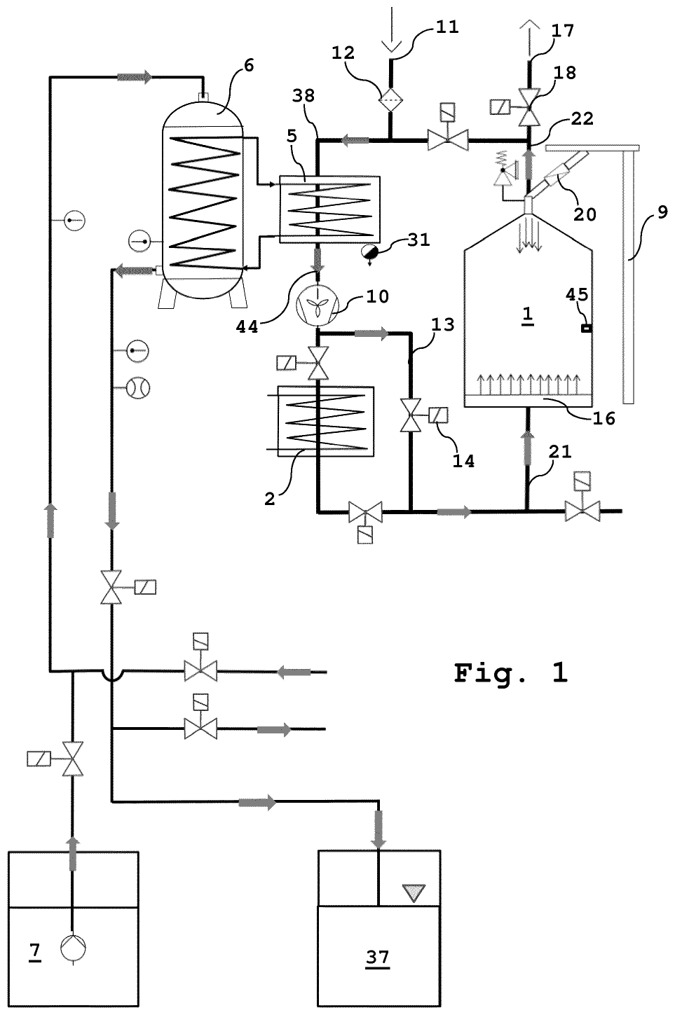

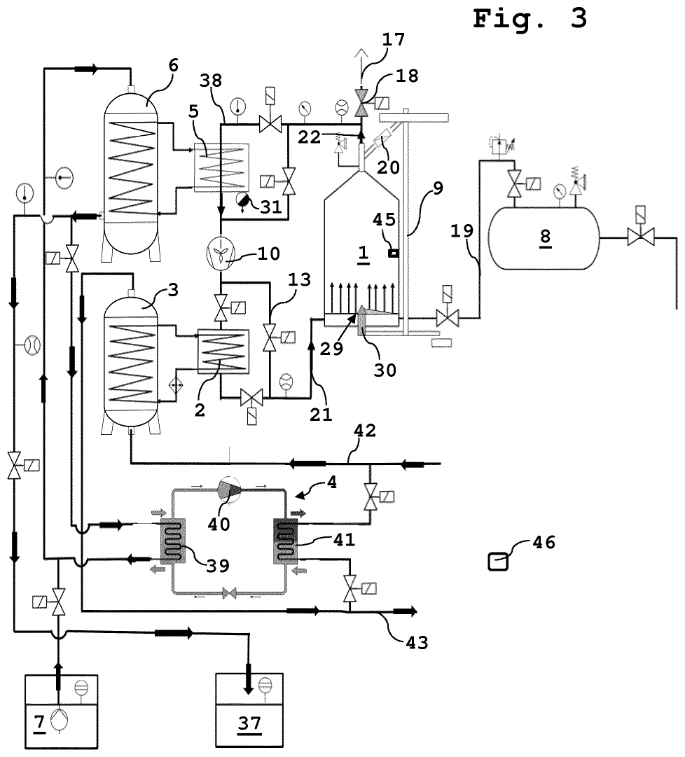

FIG. 1 shows a schematic representation of the cooling step of the method according to the invention. During the entire filling process, the bulk material, preferably harvested material, is fed via a bulk material feeder 9, preferably a lift, into a container 1, preferably a silo. The bulk material, preferably harvested material, is immediately cooled to a temperature lower than the ambient temperature, preferably 5 to 11° C. or 7 to 13° C., by means of cooling air when it is introduced. The cooling air is obtained from the ambient air and is sucked in via an air inlet 11 through a filter 12 by means of at least one fan 10, preferably a radial fan, via the line 38 to at least one second heat exchanger 5, where it is cooled by means of this heat exchanger, which is in contact with at least one cold water storage tank 6, which is supplied via a cold source, preferably a well 7 and/or a heat pump 4 (see FIG. 3). Water that has been heated by the heat exchange with the cooling air in the second heat exchanger 5 is discharged into a return seepage well 37 or fed to the heat pump 4 (see FIG. 3).

From the heat exchanger 5, the cooling air is guided via a gas line 44, the fan 10, a bypass line 13, controlled by a valve 14 and introduced via the gas supply line 21 into a preferably horizontal, round or cuboidal base of the container 1, which is provided with passage openings 16, preferably with perforated plates or slotted screens, and distributed uniformly in the interior of the container 1 preferably silos, by means of these passage openings 16. The cooling air rises upwards and thus flows through the bulk material or crop in container 1 and cools it down to a temperature of 5 to 11° C., preferably 6 to 10° C. or 7 to 13° C., preferably 8 to 12° C. By means of outlet 17, the cooling air heated by the bulk material or harvested crop is led outside via an upper valve 18. An embodiment variant in which a flap or a similar opening or closing mechanism is used instead of an upper valve 18 is conceivable.

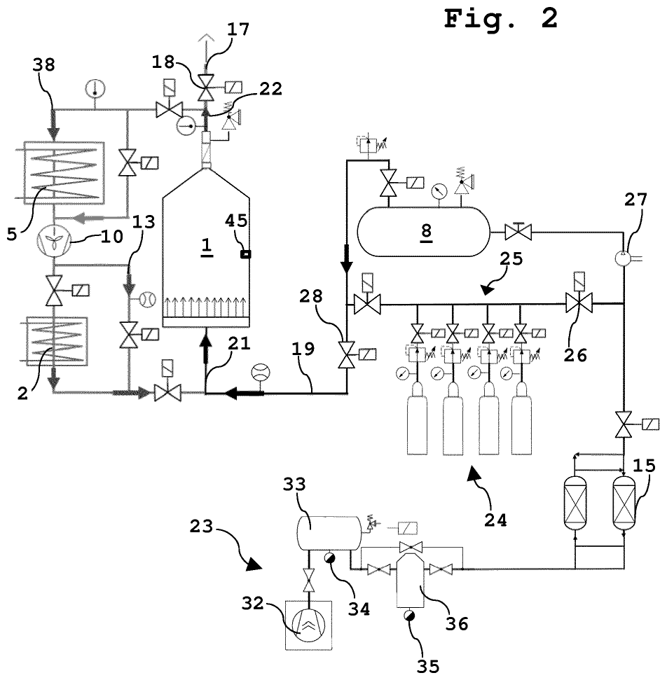

During cooling and filling of container 1 an inert gas supply line 19 (see FIG. 2) remains closed in order to avoid unnecessary consumption of inert gas. When a preferred filling level is reached, a gas-tight closable filling flap 20 or a gas-tight closable inlet slide and the gay-tight closable air inlet 11 are closed and inerting of container 1 begins.

FIG. 2 shows a schematic representation of the inerting process of the method according to the invention. First of all, an inert gas mixture, which preferably consists of nitrogen, carbon dioxide and at least one noble gas (helium, neon, argon, krypton, xenon, radon), is provided in an inert gas storage tank 8 for rapid charging <f the container 1 and for post-gassing, wherein nitrogen is preferably supplied by means of a PSA (Pressure Swing Adsorption) system 15 in combination with a compressed air system 23, which consists of compressor 32, compressed air tank 33 with condensate drain 34, dryer 36 with condensate drain 35. In a preferred embodiment variant of the method according to the invention, a cylinder storage system 24 is connected to the inert gas storage tank 8 via a dosing station 25, a solenoid valve 26 and a compressor 27. In a preferred embodiment variant, the inert gas mixture is brought to a pressure of 30-40 bar by means of compressor 27.

The inert gas mixture is passed on via a solenoid valve 28 and the gas pressure is reduced to preferably 0.1 to 0.2 bar or 0.2 to 1.0 bar by means of a pressure reducer and the gas mixture is passed into the container 1 by means of an inert gas supply line 19 and a gas supply line 21, where it is distributed uniformly inside the container 1, preferably silos, through the passage openings 16, preferably slotted screens or perforated plates. After complete filling of container 1 with the inert gas mixture, i.e. after displacement of the atmospheric oxygen, the upper valve 16 is closed.

FIG. 3 shows a schematic representation of the drying step of the method according to the invention. A gas-tight closable product outlet opening 29 is arranged at the bottom of container 1, which can be closed by means of an outlet slide or similar. A discharge screw is preferably used as the product discharge mechanism 30. When the upper valve 18 is closed, the inert gas mixture saturated with moisture is conducted via the gas discharge line 22 to the second heat exchanger 5, where water is condensed out of the gas preferably at 9 to 21° C. or 4 to 19° C. and discharged to the environment via a condensate outlet 31. The dewatered inert gas mixture is fed by fan 10 to the first heat exchanger 2, where it is brought to the desired temperature and returned via the gas supply line 21 to the interior of container 1.

Water heated by the second heat exchanger 5 can be discharged from the cold water storage tank 6 to the return seepage well 37 or fed to the heat pump 4 for cooling and supplied in a cooled down manner back to the cold water storage tank 6 again. Via heat pump 4 (consisting of evaporator 39, compressor 40 and condenser 41), hot water can be supplied to the hot water storage tank 3 via inlet 42. From another heat source 46, heat can be supplied directly to the DHW cylinder 3 via the inlet 42. Hot water can be recirculated from the hot water storage tank 3 via a return 43 to the heat pump 4 for heating or decoupled from the process.

### LIST OF REFERENCE NUMERALS

1 Container

2 First heat exchanger

3 Hot water storage tank

4 Heat pump

5 Second heat exchanger

6 Cold water storage tank

7 Well

8 Inert gas storage tank

9 Bulk material feeder

10 Fan

11 Aft inlet

12 Filter

13 Bypass line

14 Valve

15 PSA system

16 Passage openings

17 Outlet

18 Upper valve

19 Inert gas supply line

20 Filling flap

21 Gas supply line

22 Gas discharge line

23 Compressed air system

24 Cylinder storage system

25 Dosing station

26 Solenoid valve

27 Compressor

28 Solenoid valve

29 Product outlet opening

30 Product discharge

31 Condensate outlet 3

32 Compressor

33 Compressed air tank

34 Condensate drain

35 Condensate drain

36 Dryer

37 Return seepage well

38 Line

39 Evaporator

40 Compressor

41 Condenser

42 Inlet

43 Return

44 Gas line

45 Sensors

46 Other heat source

1. A method for convective drying of bulk material in a container, wherein in a drying step a gas mixture flows around the bulk material to be dried in the container, which gas mixture takes up water contained in the bulk material to be dried and is then discharged from the container, wherein before the drying step a cooling step is carried out in which the bulk material is brought to a temperature lower than the ambient temperature, wherein both the cooling step and the drying step take place in the same gas-tight container, wherein the drying step takes place in an inert atmosphere, the inert atmosphere is produced by introducing an inert gas mixture into the container, the inert gas mixture consists of nitrogen, carbon dioxide and at least one noble gas, preferably argon, in the drying step the gas mixture is heated via a first heat exchanger, which is connected to a hot-water storage tank, the cooling air is cooled by a second heat exchanger, which is connected to a cold water storage tank, and process heat is recovered by means of a heat pump from water which originates from the cold water storage tank and has been heated by heat exchange in the second heat exchanger, and which water is supplied to the hot water storage tank, via the heat pump by means of an inlet.

2. The method according to claim 1, wherein the inert gas mixture consists of 70-95% nitrogen, 5-10% argon, and 2-4% carbon dioxide.

3. The method according to claim 1, wherein, in a final phase of the drying step for sterilizing the bulk material, the dosage of the carbon dioxide in the inert gas mixture is increased to 5-20%.

4. The method according to claim 1, wherein a shifting of the bulk material takes place in the drying step.

5. The method according to claim 1, wherein in the drying step the gas mixture saturated with moisture is condensed out before renewed heating.

6. The method according to claim 1, wherein the hot water storage tank is additionally fed from at least one of the following sources: geothermal energy, process heat or solar collectors.

7. The method according to claim 1, wherein the energy for the heat pump is additionally taken from a well or another heat source with heat recovery.

8. The method according to claim 1, wherein the cooling step is implemented by means of cooling air.

9. The method according to claim 8, wherein ambient air is used as cooling air.

10. The method according to claim 1, wherein the temperature in the container is lowered to 5 to 13° C. during the cooling step.

11. The method according to claim 10, wherein the cold water storage tank is additionally fed by a well.

12. The method according to claim 1, wherein additional bulk material is introduced into the container during the cooling step.

13. The method according to claim 1, wherein the gas mixture is circulated in a gas-tight closed system.

14. A drying device for convective drying of bulk material in a container, comprising means for introducing bulk material into a gas-tight container and means for discharging bulk material from the container, a gas supply line and a gas discharge line, wherein a first and a second heat exchanger are connected to the container, wherein the second heat exchanger can be used for cooling and the first heat exchanger can be used for heating a gas mixture which can be supplied to the gas-tight container via the gas supply line, wherein an inert gas storage tank is connected to the container, in particular via the gas supply line, for supplying inert gas into the container, the first heat exchanger is connected to a hot water storage tank, the hot water storage tank is connected to at least one heat pump as the source, the heat pump is connected to at least one cold water storage tank as the source, and the second heat exchanger is connected to a cold water storage tank, and that process heat can be recovered by means of a heat pump from water which originates from the cold water storage tank and has been heated by heat exchange in the second heat exchanger, and which water can be supplied to the hot water storage tank via the heat pump by means of an inlet.

15. The drying device according to claim 14, wherein at least one inert gas source can be connected to a supply line to the inert gas storage tank.

16. The drying device according to claim 14, wherein at least one means for shifting the bulk material is present in the container. cm 17. The drying device according to claim 16, wherein the hot water storage tank is connected to at least one of the following sources: geothermal energy, process heat, solar collectors.

18. The drying device according to claim 17, wherein the heat pump is connected to at least one of the following sources: geothermal energy, solar collectors or other heat sources with heat recovery.

19. The drying device according to claim 14, wherein the cold water storage tank is connected to a well.

20. The drying device according to claim 14, wherein an air inlet for ambient air is provided, which is connected to the second heat exchanger for cooling the ambient air, and the cooled ambient air can be conducted via a bypass line, by excluding the first heat exchanger, through the gas supply line into the container.

21. The drying device according to claim 14, wherein the container is connected via the gas discharge line to the second heat exchanger for the purpose of condensing water from the gas mixture, which communicates via a gas line with the first heat exchanger, which is connected via the gas supply line to the container in a closed circuit for the gas mixture.

22-25. (canceled)

26. The method of claim 1 wherein the 70-95% nitrogen comprises 90% nitrogen.

27. The method of claim 1 wherein the 5-10% argon comprises 7% argon.

28. The method of claim 1 wherein the 2-4% carbon dioxide comprises 3% carbon dioxide.

29. The method of claim 10 wherein the 5 to 13° C. comprises 6 to 12° C.

30. The drying device of claim 14 wherein the inert gas storage tank is connected to the container via the gas supply line.
